(19) United States
(12) Patent Application Publication
(10) Pub. No.: US 2006/0154204 A1
(43) Pub. Date: Jul. 13, 2006

(54) Dental implants with improved loading properties

(76) Inventor: John A. Reggie, Menlo Park, CA (US)

Correspondence Address: O'MELVENY & MYERS LLP, 610 NEWPORT CENTER DRIVE, 17TH FLOOR, NEWPORT BEACH, CA, 92660, US

(21) Appl. No.: 11/035,312

(22) Filed: Jan. 12, 2005

(51) Int. Cl. A61C 8/00

(52) U.S. Cl. 433/173

(57) ABSTRACT

A dental prosthetic comprising an elongate threaded implant adapted to be secured within the trabecular region of a maxilla or mandible. An abutment is secured to the elongate threaded implant and adapted to receive a crown. The abutment and elongate threaded implant extend generally along a common longitudinal axis. A generally flat surface is secured to a region where the abutment meets the implant and extends generally perpendicular to the axis of the abutment and implant. The generally flat surface is shaped to engage the cortical region of the maxilla or mandible, and thereby minimize micromotion and allow for osseointegration despite immediate installation of a crown and immediate mechanical loading. Methods for implanting dental prosthetics are also described.

### FIELD OF THE INVENTION

The invention relates to devices and methods for replacing teeth with dental implants.

### BACKGROUND

Traditionally, dentures or bridges are often used to treat patients who have lost some or all teeth on their upper jaw (maxilla) or lower jaw (mandible). A reparative option that is gaining popularity is the use of a dental implant with a prosthetic crown attached above the gumline. The implants can also be used in patients having damaged teeth, such as malformed or malpositioned teeth. These implants, usually made of titanium, are screwed into the jawbone after a receiving hole is drilled into the bone.

There are two general classifications of bone—trabecular and cortical. Cortical bone is a dense, hard, and stiff material that makes up the outer surface of bones while trabecular bone is a porous and softer material that makes up the inner core of the bone. Because conventional implants are threaded into the trabecular bone through a hole drilled through the cortical bone, much of the load is transferred from the prosthetic tooth, through the implant, and to the surface between the implant and the trabecular bone. Unfortunately, trabecular bone may not have adequate thickness and strength to keep micromotion below the required level before the two surfaces have grown together.

A disadvantage of current implant systems is that patients often have to wait for a duration of three to six months or more to avoid mechanical loading the implants (as in chewing) to allow bonding by ingrowth into surface crevices of the implant, i.e., osseointegration. Movement between the implant and the bone (commonly known as “micromotion”) can cause formation of a layer of fibrous tissue between the implant and the bone and prevents optimal bonding between the two surfaces. It has been shown that micromotion must be kept below 50 to 150 micrometers to allow growth between the implant and the trabecular bone.

Therefore, new tooth prosthetics are needed that will permit osseointegration and minimize micromotion despite securing a crown at the same time the implant is installed. New prosthetic devices and methods are therefore needed that will allow immediate mechanical loading without waiting for a period of months and still result in successful osseointegration.

### SUMMARY OF THE INVENTION

The present invention relates to dental implants and prosthetic devices that allow for immediate installation of a crown, immediate mechanical loading during use of the implants, and that minimize micromotion during loading to permit osseointegration with the implant despite immediate use. In a first embodiment, the dental prosthetic comprises an elongate threaded implant that is secured within the trabecular region of the maxilla or mandible. An abutment is secured to the elongate threaded implant and is adapted to receive a crown. The abutment and implant may be of a unitary construction or separate components that are secured after implantation. Both the implant and the abutment are generally elongate components. Once secured to the implant, the abutment is typically oriented generally along the same longitudinal axis as the implant. In other embodiments, the axis of the abutment is angled relative to the axis of the implant, generally by one degree or less, two degrees or less, three degrees or less, four degrees or less, five degrees or less, six degrees or less, seven degrees or less, eight degrees or less, nine degrees or less, or ten degrees or less.

A generally flat surface member may be secured to the region where the abutment meets the implant. The flat surface extends generally perpendicular to the axis of the abutment and the implant. The flat surface is typically made of flexible titanium, flexible stainless steel, or other flexible material suitable for use as a dental implant and known in the art. The flat surface is shaped to engage the cortical region of the maxilla or mandible. In certain cases, the flat surface extends to a curved region that engages a vertical surface of the cortical region of the jawbone. In other cases, there will be two curved regions at opposite ends of the flat surface, one to engage an inner vertical surface of the jawbone and the other to engage the outer surface of the jawbone. In still other embodiments, the flat surface includes at least one anchoring element to secure the flat surface to the cortical region of the jawbone. The anchoring element can be located on the flat surface, on one or more curved region, or on both. The anchoring element may comprise a barb or other suitable structure. The generally flat surface may be integral with the implant, integral with the abutment, integral with both, or not integral with either.

In certain embodiments, the portion of the implant that secures the cortical bone, e.g., the generally flat surface, is formed of a compliant material, e.g., elastic titanium or elastic stainless steel that will conform to an irregular surface of the bone. The generally flat surface will have an elastic property that will allow the structure to conform to the bone and form a tight seal against the bone. By forming a tight seal the compliant structure (1) helps reduce the chances of bacterial infiltration between the implant and the bone, and (2) reduces the amount of movement between the bone and implant.

A compliant structure will also allow for small adjustments to be made by rotating the implant. This may be advantageous where, for example, the trajectory of drilling the receiving hole in the bone is not correct to achieve alignment with adjacent teeth. The hole in the implant that receives the abutment may be offset relative to the axis of the implant. Thus, as the implant is rotated, the angle of the abutment relative to the adjacent teeth will adjust. By use of a compliant material for the generally flat surface, the curved region, or “wings,” can be lifted, the implant rotated to achieve the correct angle for the abutment, and the curved region allowed to fall back in place around the bone structure. Here, after rotation, the wings may have to fold along a new line to tightly wrap around the bone structure. Use of a compliant material allows the wings to fold along a new line after the implant is rotated.

Bacterial infiltration can cause bone reduction and degradation. A tight fit is therefore desired between the bone and the flat structure. The curved regions at the ends of the generally flat structure may be biased inwardly to assure the formation of a tight seal with the bone structure. In this manner the curved regions will be pried open, placed over the ridge of the maxilla or mandible, and released to snap down tightly over the maxilla or mandible. In some cases the titanium or stainless steal is cut with thin spots to give strain relief and bending properties. In other cases, the bone structure is ground down to make a flat surface to receive the implant.

In use, the devices described herein function as a replacement for tooth loss. Osteotomy is created by drilling into the maxilla or mandible at the location of the missing tooth. The implant is inserted into position within the trabecular region of the jawbone. Where the flat surface is pre-attached to the implant, the implant is threaded until the flat surface engages the cortical region of the jawbone. In cases where the flat surface is not attached to the implant, the generally flat surface is then attached after placement of the implant so that the flat surface tightly engages the cortical surface. The abutment extends from the jawbone once the implant is in place, or is then attached to the implant. A crown is then secured to the abutment.

In certain cases, the flat surface extends to one or more curved regions that are shaped to engage the inner and outer vertical surfaces of the cortical region of the mandible or maxilla. The curved regions may be elastically deformable and biased inward so as to tightly engage the vertical surfaces of the bone. During installation, the vertical regions are pried apart, placed over the bone, and released to form a tight fit with the bone. In other cases, one or more anchoring elements are placed to engage, and possibly penetrate, the cortical surface of the jawbone.

### BRIEF DESCRIPTION OF THE DRAWINGS

FIG. 1A depicts a unitary implant with flat surface and abutment.

FIG. 1B depicts the unitary implant of FIG. 1A having anchoring elements.

FIG. 2A depicts the implant of FIG. 1B engaging a jawbone.

FIG. 2B depicts an expanded view of FIG. 2A having an anchoring element penetrating the cortical bone structure.

FIG. 2C depicts an alternative implant structure with anchoring elements disposed to contact the horizontal surface of the cortical bone structure.

FIG. 2D depicts an implant with anchoring elements contacting both horizontal and vertical surfaces of the cortical bone structure.

FIG. 3A depicts an implant having unitary flat surface element and a separate attachable abutment.

FIG. 3B depicts a threaded implant with a separate, unitary abutment and flat surface element attachable to the implant.

FIG. 4A depicts the implant of FIG. 3A engaging a jawbone structure.

FIG. 4B depicts the implant of FIG. 4A after attachment of the abutment.

FIG. 5A depicts the implant of FIG. 3B installed within the trabecular bone structure.

FIG. 5B depicts the installed implant of FIG. 5A having abutment and flat surface element attached.

FIG. 6 depicts an implant having a circular flat surface element.

### DETAILED DESCRIPTION

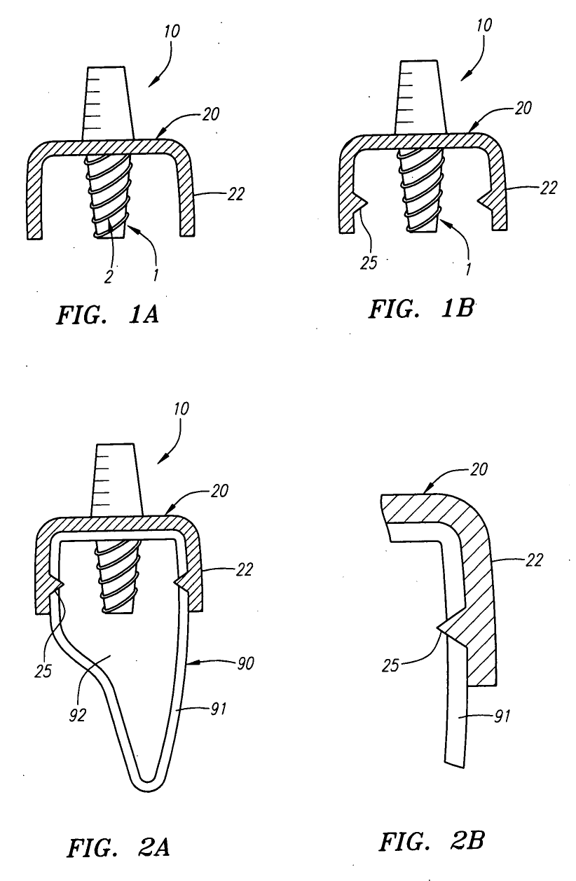

FIG. 1A depicts a first embodiment of the implant described herein. Implant 1 contains threaded region 2 designed to enter and be threaded into the trabecular region of a bone. Abutment 10 extends from one end of implant 1. A generally flat surface, element 20, extends from an intermediate region between implant 1 and abutment 10, and lies in a plane perpendicular to the axis of the implant and abutment. Flat surface element 20 may include curved regions 22, which are shaped to extend along the vertical inner and outer surfaces of the mandible or maxilla. FIG. 11B shows the implant device with anchoring elements, here barbs 25, placed on the inside surface of curved region 22. The implant is typically formed of titanium or stainless steel, but is desirably made of flexible titanium of stainless steel so that it tightly conforms to and engages the cortical surface of the bone structure despite surface irregularities that will be present on the surface even after grinding or filing to remove irregularities.

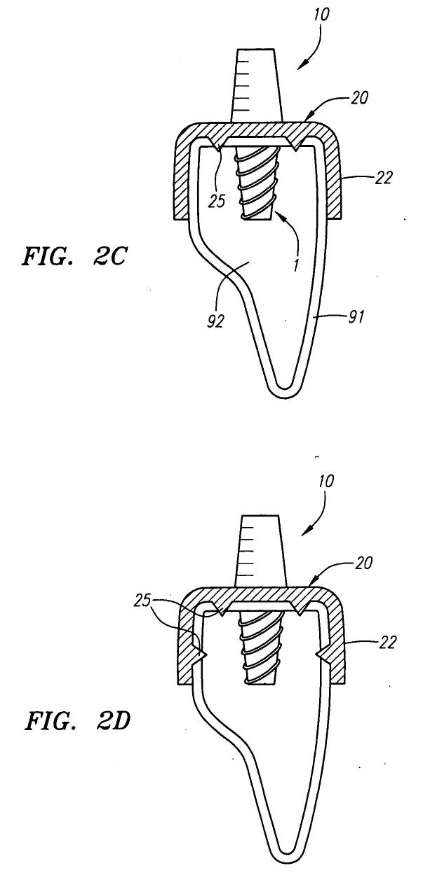

FIG. 2A depicts mandible or maxilla 90, having cortical bone structure 91 and trabecular bone structure 92. Implant 1 extends into trabecular bone structure 92. Abutment 10 extends above bone 90. Flat surface member 20 extends laterally along the horizontal surface of cortical bone structure 91. Curved regions 22 extend along the vertical surface of cortical bone structure 91. Anchoring elements 25 are secured to the surface of cortical bone structure 91. This device minimizes lateral, vertical, and torsional micromotion because flat surface member 20 acts as a brace to secure the implant to the more rigid cortical bone structure, thereby minimizing movement within trabecular bone structure 92. Reduction in micromotion aids the process of osseointegration. FIG. 2B is an expanded version of FIG. 2A showing anchoring element 25 secured to the vertical surface of cortical bone structure 91. FIG. 2C shows anchoring elements 25 secured to the horizontal surface of cortical bone structure 91. FIG. 2D shows anchoring elements 25 secured to both the horizontal and vertical surfaces of cortical bone structure 91.

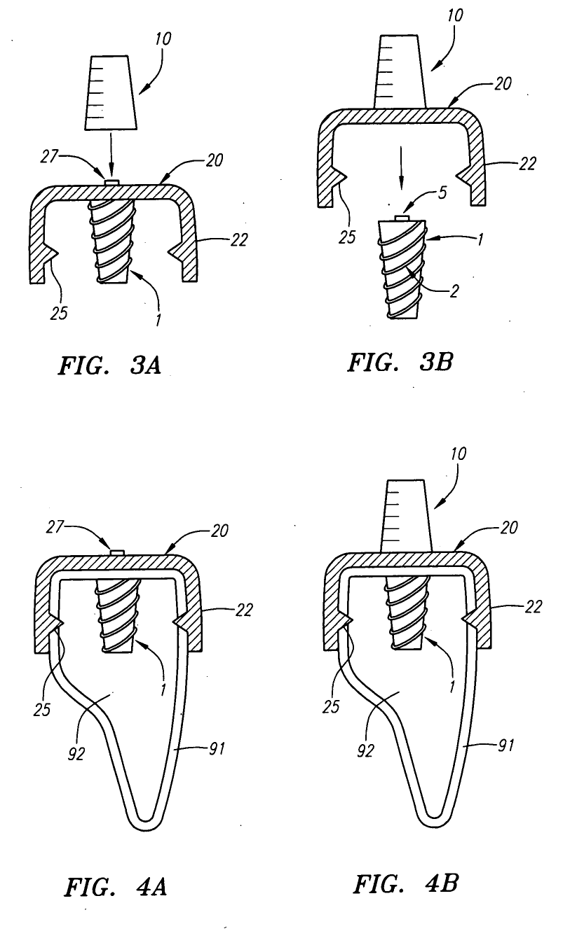

FIG. 3A shows an alternative design of the prosthetic described herein. Threaded implant 1 includes flat surface member 20 and optional curved regions 22 with one or more optional anchoring elements 25. Flat surface 20 includes post 27 for attachment of abutment 10 before or after the implant is secured to the bone structure. It will be understood that curved regions 22, when present, will be deflected away from threaded implant 1 during installation to allow implant 1 to be inserted like a screw into the bone structure. In certain cases, a clip (not shown) holds the curved regions 22 in a position deflected away from threaded implant 1 during installation. After the implant is fully threaded into the bone, curved regions 22 are released (by removal of the clip when present) and snap down to tightly engage the cortical surface of the bone. FIG. 4A depicts placement into a mandible or maxilla bone structure, and FIG. 4B shows attachment of abutment 10.

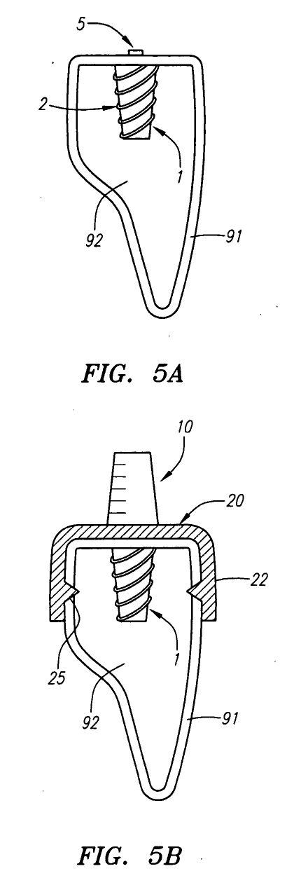

FIG. 3B shows an alternative design of the prosthetic described herein. Threaded implant 1 is first inserted into the bone like a screw into a drilled receiving hole in the bone. Implant 1 includes post 5 for attachment of abutment 10 and flat surface member 20. Abutment 10 and flat surface 20 can be made unitary or of two separate pieces that are attached at the time of surgery. FIG. 5A depicts placement of implant 1 into a mandible or maxilla bone structure, and FIG. 5B shows attachment of abutment 10 and flat surface member 20 with optional curved regions 22 with one or more optional anchoring elements 25.

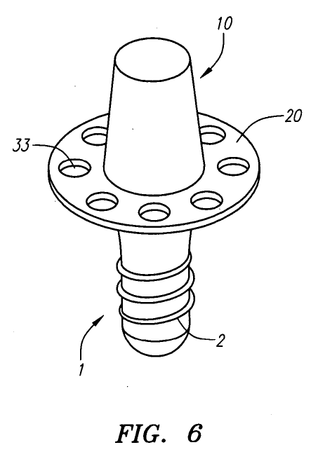

FIG. 6 shows a further alternative design of the prosthetic described herein. Implant 1 contains threaded region 2 designed to enter and be threaded into the trabecular region of a bone. Abutment 10 extends from one end of implant 1. A generally flat surface, element 20, extends from an intermediate region between implant 1 and abutment 10, and lies in a plane perpendicular to the axis of the implant and abutment. Flat surface element 20 is generally circular. This shape allows the implant to be threaded into the bone by any number of turns to achieve optimal insertion. The flat surface can then be bent over the vertical edges of the jawbone. Moreover, the axis of the abutment may be angled relative to the axis of the implant. This way, the placement of the crown can be adjusted to align with the adjacent teeth. Flat surface element 20 may also include one or more holes 33 that allow the gum tissue to maintain contact with the bone and thereby reduce the chance for infection.

Although the foregoing invention has, for the purposes of clarity and understanding, been described in some detail by way of illustration and example, it will be obvious that certain changes and modifications may be practiced which will still fall within the scope of the appended claims. It will also be understood that any feature or features from any one embodiment, or any reference cited herein, may be used with any combination of features from any other embodiment.

What is claimed is:

1. A dental prosthetic, comprising;
an elongate threaded implant adapted to be secured within the trabecular region of a maxilla or mandible;
an abutment secured to the elongate threaded implant and adapted to receive a crown, the abutment and elongate threaded implant extending along a generally common longitudinal axis; and
a generally flat surface secured to a region where the abutment meets the implant and extending generally perpendicular to the axis of the abutment and implant, the generally flat surface being shaped to engage the cortical region of the maxilla or mandible.

2. The dental prosthetic of claim 1, wherein the generally flat surface extends to a curved region that engages a vertical surface of the cortical region of the maxilla or mandible.

3. The dental prosthetic of claim 1, wherein the generally flat surface includes at least one anchoring element adapted to secure the generally flat surface to the cortical region of the maxilla or mandible.

4. The dental prosthetic of claim 2, wherein the curved region includes at least one anchoring element adapted to secure the un-curved region to the cortical region of the maxilla or mandible.

5. The dental prosthetic of claim 3, wherein the anchoring element comprises a barb.

6. The dental prosthetic of claim 1, wherein the implant is made of titanium.

7. The dental prosthetic of claim 1, wherein the implant is a screw.

8. The dental prosthetic of claim 1, wherein the implant and the abutment are integral.

9. The dental prosthetic of claim 1, wherein the implant and the abutment are separable and attachable.

10. The dental prosthetic of claim 1, wherein the generally flat surface is secured to the implant.

11. The dental prosthetic of claim 1, wherein the generally flat surface is secured to the abutment.

12. The dental prosthetic of claim 1, wherein the generally flat surface has an outer perimeter that is generally circular in shape.

13. The dental prosthetic of claim 1, wherein the generally flat surface has at least one hole that allows gum tissue to contact the cortical region of the maxilla or mandible.

14. A method for replacing a tooth, comprising the steps of;
providing a dental prosthetic comprising an elongate threaded implant, an abutment secured to the implant, and a generally flat surface secured to a region where the abutment meets the implant and extending generally perpendicular to a longitudinal axis of the abutment and implant;
inserting the implant into position within the trabecular region of the maxilla or mandible so that the generally flat surface engages the surface of the cortical region of the maxilla or mandible and the abutment extends from the maxilla or mandible; and
securing a crown to the abutment.

15. The method of claim 14, wherein generally flat surface extends to a curved region that engages a vertical surface of the cortical region of the maxilla or mandible.

16. The method of claim 14, wherein the generally flat surface includes at least one anchoring element adapted to secure the generally flat surface to the cortical region of the maxilla or mandible.

17. The method of claim 15, wherein the curved region includes at least one anchoring element adapted to secure the un-curved region to the cortical region of the maxilla or mandible.

18. A method for replacing a tooth, comprising the steps of;
providing a dental prosthetic comprising an elongate threaded implant and a generally flat surface secured at one end of the implant and extending generally perpendicular to a longitudinal axis of the implant;
inserting the implant into position within the trabecular region of the maxilla or mandible so that the generally flat surface engages the surface of the cortical region of the maxilla or mandible;
securing an abutment to the implant so that the abutment extends from the maxilla or mandible; and
securing a crown to the abutment.

19. The method of claim 18, wherein the generally flat surface extends to a curved region that engages a vertical surface of the cortical region of the maxilla or mandible.

20. The method of claim 18, wherein the generally flat surface includes at least one anchoring element adapted to secure the generally flat surface to the cortical region of the maxilla or mandible.

21. The method of claim 19, wherein the curved region includes at least one anchoring element adapted to secure the un-curved region to the cortical region of the maxilla or mandible.

22. A method for replacing a tooth, comprising the steps of;
providing a dental prosthetic comprising an elongate threaded implant and a dental prosthetic comprising an abutment and a generally flat surface secured at one end of the abutment and extending generally perpendicular to a longitudinal axis of the abutment;
inserting the implant into position within the trabecular region of the maxilla or mandible;
securing the abutment to the implant so that the generally flat surface engages the surface of the cortical region of the maxilla or mandible and the abutment extends from the maxilla or mandible; and
securing a crown to the abutment.

23. The method of claim 22, wherein generally flat surface extends to a curved region that engages a vertical surface of the cortical region of the maxilla or mandible.

24. The method of claim 22, wherein the generally flat surface includes at least one anchoring element adapted to secure the generally flat surface to the cortical region of the maxilla or mandible.

25. The method of claim 23, wherein the curved region includes at least one anchoring element adapted to secure the un-curved region to the cortical region of the maxilla or mandible.
